(19) United States
(12) Patent Application Publication
(10) Pub. No.: US 2025/0100720 A1
(43) Pub. Date: Mar. 27, 2025

(54) SYSTEMS AND METHODS FOR DETECTING HYPERSONIC VEHICLES

(71) Applicant: Viasat, Inc., Carlsbad, CA (US)

(72) Inventors: David D. GREENIDGE, Longmont, CO (US); James W. STARTUP, Tempe, AZ (US); Kenneth V. BUER, Bluff City, TN (US)

(21) Appl. No.: 18/728,324

(22) PCT Filed: Jan. 5, 2023
(86) PCT No.: PCT/US2023/010211

§ 371 Date: Jul. 11, 2024

Related U.S. Application Data
(60) Provisional application No. 63/299,206, filed on Jan. 13, 2022.

(51) Int. Cl. B64G 3/00; G01S 13/02

(52) U.S. Cl. CPC B64G 3/00; G01S 13/02; G01S 2013/0254

(57) ABSTRACT

Methods, systems, and devices for communication are described. Multiple beams having multiple coverage areas that cover an area-of-interest may be formed. Respective signal profiles may be measured for the coverage areas. Based on the measuring, a signal profile that satisfies a criterion relative to the other signal profiles may be detected. Based on detecting that a signal profile satisfies the criterion, a presence of a vehicle in the area-of-interest may be determined.

### CROSS REFERENCE

The present application is a 371 national phase filing of International Patent Application No. PCT/US2023/010211 by GREENIDGE et al. entitled, “SYSTEMS AND METHODS FOR DETECTING HYPERSONIC VEHICLES,” filed Jan. 5, 2023, and which claims priority to U.S. Provisional Patent Application No. 63/299,206 by GREENIDGE et al., entitled “SYSTEMS AND METHODS FOR DETECTING HYPERSONIC VEHICLES” filed Jan. 13, 2022, each of which is assigned to the assignee hereof and each of which is hereby incorporated by reference in its entirety.

### BACKGROUND

The following relates generally to object detection, including detecting hypersonic vehicles.

Certain aerial vehicles may travel through the atmosphere (e.g., lower or upper atmosphere) at hypersonic speeds (e.g., greater than five times the speed of sound). Vehicles that travel at hypersonic speed may be capable of evading conventional tracking techniques, such as ground-based radar techniques. For example, such vehicles may evade tracking by following non-standard trajectories or by flying below the line-of-flight detection capability of ground-based systems. Such vehicles may also be capable of evading space-based radar techniques, as the vehicles may be darkened and difficult to detect from above. Thus, improved techniques and configurations for detecting vehicles (including hypersonic vehicles) may be desired.

### SUMMARY

Configurations and techniques for object detection are described. Multiple beams having multiple coverage areas that cover an area-of-interest may be formed. Respective signal profiles may be measured for the coverage areas. Based on the measuring, a signal profile that satisfies a criterion relative to the other signal profiles may be detected. Based on detecting that a signal profile satisfies the criterion, a presence of a vehicle in the area-of-interest may be determined. In some examples, a signal profile is based on a measured thermal noise floor in a respective coverage area and compared with a baseline thermal noise floor determined for the coverage areas. Additionally, or alternatively, a signal profile may be based on a spectral signature in a respective coverage area and compared with a baseline spectral signature determined for the coverage areas.

### BRIEF DESCRIPTION OF THE DRAWINGS

FIG. 1 shows an example of a system that supports detecting hypersonic vehicles in accordance with examples as disclosed herein.

FIG. 2 shows an example of a detection device that supports detecting hypersonic vehicles in accordance with examples as disclosed herein.

FIG. 3 shows an example of a beam pattern for an area of-interest that supports detecting hypersonic vehicles in accordance with examples as disclosed herein.

FIG. 4 shows an example of a beam pattern for an area of-interest that supports detecting hypersonic vehicles in accordance with examples as disclosed herein.

FIG. 5 shows an example of a beam pattern for an area of-interest that supports detecting hypersonic vehicles in accordance with examples as disclosed herein.

FIG. 6 shows an example of a spectral pattern that supports detecting hypersonic vehicles in accordance with examples as disclosed herein.

FIG. 7 shows an example of a set of operations for detecting hypersonic vehicles in accordance with aspects of the present disclosure.

### DETAILED DESCRIPTION

Certain aerial vehicles may travel through the atmosphere (e.g., lower or upper atmosphere) at hypersonic speeds (e.g., greater than five times the speed of sound). Vehicles that travel at hypersonic speed may be capable of evading conventional tracking techniques, such as ground-based radar techniques. For example, such vehicles may evade tracking by following non-standard trajectories or by flying below the line-of-flight detection capability of ground-based systems. Such vehicles may also be capable of evading space-based radar techniques, as the vehicles may be darkened and difficult to detect from above. Thus, improved techniques and configurations for detecting vehicles (including hypersonic vehicles) may be desired.

To detect hypersonic vehicles, a monitoring station may be configured to form respective beam arrays that cover respective aerial or space-based areas of interest (which may be referred to as detection areas). The formed beam arrays may be used to detect vehicles travelling through the areas of-interest, including vehicles travelling through the areas of-interest at hypersonic speeds. In some examples, to detect the vehicles, the monitoring station may be configured to detect changes in a thermal noise floor of one or more beams relative to the other beams in the beam array. Additionally, or alternatively, to detect the vehicles, the monitoring station may be configured to detect changes in a molecular spectral signature (e.g., an O₂ spectral signature) of one or more beams relative to the other beams in the beam array.

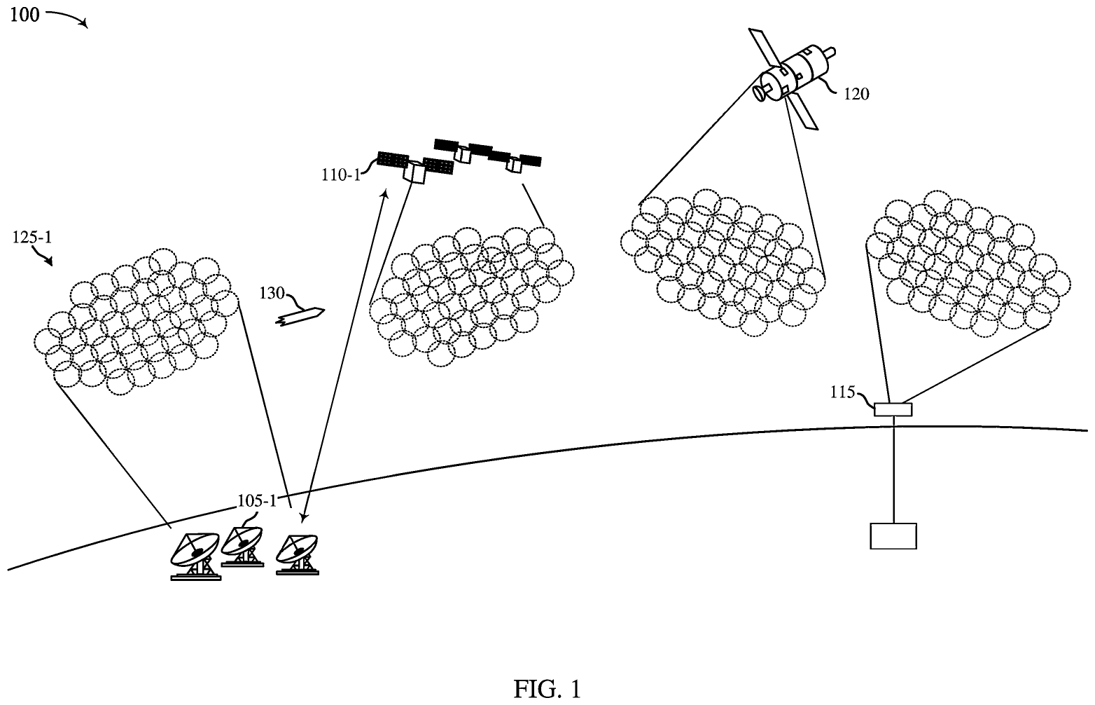

FIG. 1 shows an example of a system that supports detecting hypersonic vehicles in accordance with examples as disclosed herein.

The system 100 may include ground stations (such as the first ground station 105-1), low earth orbit (LEO) satellites (such as the first LEO satellite 110-1), aerial stations (such as the aerial station 115), and geostationary orbit (GEO) satellites (such as the GEO satellite 120). The system 100 may also include medium earth orbit (MEO) satellites (not shown) that are positioned in orbits located between low earth orbits and geostationary orbits. The aerial stations may have hovering capabilities, such as a surveillance balloon. The satellites may be configured to support communications, and may be configured with communication circuitry (e.g., antennas, power amplifiers, low noise amplifiers, decoders, demodulators, diplexers, encoders, modulators, local oscillators, beamformers, or any combination thereof). The ground and aerial stations may similarly be configured with communication circuitry.

Certain aerial vehicles may travel through the atmosphere (e.g., lower or upper atmosphere) at hypersonic speeds (e.g., greater than five times the speed of sound). Vehicles that travel at hypersonic speed may be capable of evading conventional tracking techniques, such as ground-based radar techniques. For example, such vehicles may evade tracking by following non-standard trajectories or by flying below the line-of-flight detection capability of ground-based systems. Such vehicles may also be capable of evading space-based radar techniques, as the vehicles may be darkened and difficult to detect from above. Thus, improved techniques and configurations for detecting vehicles (including hypersonic vehicles) may be desired.

To detect hypersonic vehicles, the ground stations, LEO satellites, GEO satellites, MEO satellites, aerial stations, or any combination thereof, in the system 100 may be configured to form respective beam arrays (such as the first array of beams 125-1) having coverage areas that cover respective aerial or space-based areas-of-interest. The formed beam arrays may be used to detect vehicles (e.g., such as the vehicle 130) travelling through the areas of-interest, including vehicles travelling through the areas of-interest at hypersonic speeds. In some examples, to detect the vehicles, the monitoring station may be configured to detect changes in a thermal noise floor of one or more beams relative to the other beams in the beam array. Additionally, or alternatively, to detect the vehicles, the monitoring station may be configured to detect changes in a molecular spectral signature (e.g., an O₂ spectral signature) of one or more beams relative to the other beams in the beam array.

In some examples, a monitoring station (e.g., a ground station, LEO satellite, GEO satellite, MEO satellite, aerial station, or any combination thereof) may form multiple beams having respective coverage areas that cover an area-of-interest. In some examples, the monitoring station is selected to be a station that looks upward (e.g., a ground or aerial-based station) to avoid heat signatures generated by land-based geography (e.g., a shoreline). Based on forming the beams, the monitoring station may measure respective signal profiles in the respective coverage areas. Based on measuring the respective signal profiles, the monitoring station may detect that one or more signal profiles for one or more of the beams satisfies a criterion relative to the signal profiles of the other beams. For example, the monitoring station may determine that the one or more beams have thermal noise that exceed a baseline thermal noise threshold established for the multiple beams. Additionally, or alternatively, the monitoring station may determine that the one or more beams have spectral signatures that differ from a spectral signature baseline established for the multiple beams. Based on detecting that the one or more signal profiles satisfy the criterion, the monitoring station may identify a presence of a vehicle in the area.

By continuously monitoring thermal noise and/or spectral signatures associated with multiple beam coverage areas, disturbances in the beam coverage areas caused by fast moving vehicles may be detected, and thus fast moving vehicles, may be detected relative to baseline criteria. Also, by monitoring radio frequency signals in the multiple beam coverage areas, conventional communication hardware and techniques may be repurposed to detect fast moving vehicles.

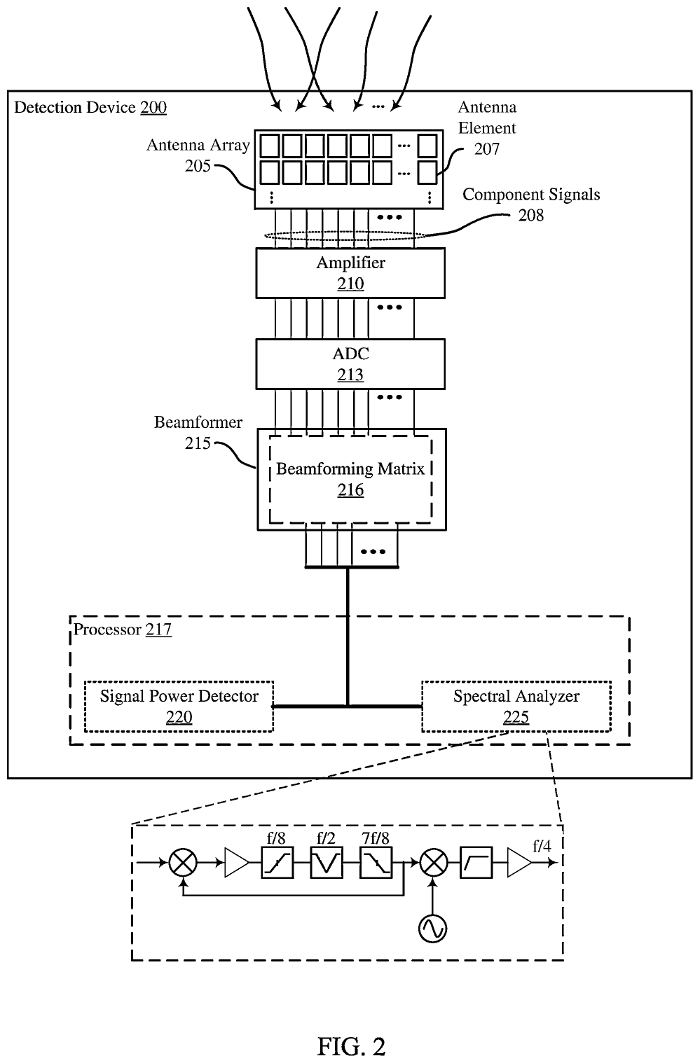

FIG. 2 shows an example of a detection device that supports detecting hypersonic vehicles in accordance with examples as disclosed herein.

The detection device 200 may be configured to detect objects that travel through a an area-of-interest (e.g., an area-of-interest covered by the first array of beams 125-1 of FIG. 1). In some examples, the detection device 200 may be configured to monitor thermal noise in beams that cover the area-of-interest. In such cases, the detection device 200 may include the antenna array 205, the amplifier 210, the analog-to-digital converter 213, the beamformer 215, and the signal power detector 220. In some examples, the detection device 200 may be configured to monitor spectral patterns in beams that cover the area-of-interest. In such cases, the detection device 200 may include the antenna array 205, the amplifier 210, the analog-to-digital converter 213, the beamformer 215, and the spectral analyzer 225. The operations of the signal power detector 220 and the spectral analyzer 225 may be implemented within the processor 217. In some examples, the detection device 200 may be capable of monitoring thermal noise, spectral patterns, or both, and the detection device 200 may include each of the previously listed components. The detection device 200 may be coupled with or located at a ground station (e.g., the first ground station 105-1), a LEO satellite (e.g., the first LEO satellite 110-1), a GEO satellite (e.g., the GEO satellite 120), or an aerial station (e.g., the aerial station 115). In some examples, aspects of the detection device 200 may be located at different stations—e.g., an aerial station for detecting signals and a ground station for processing the signals.

The antenna array 205 may include multiple antenna elements 207 (e.g., that are distributed evenly or unevenly across an area). The antenna array 205 may be configured to detect electromagnetic signals originating from an area-of-interest, where different antenna elements 207 of the antenna array 205 may receive different versions of electromagnetic signals received at the antenna array 205 based on a location of the antenna elements 207 in the antenna array 205 relative to the origination points of the electromagnetic signals. In some examples, each antenna element 207 may output a component signal corresponding to the version of the electromagnetic signals received at the antenna element 207. The amplifier 210 may be configured to amplify the component signals 208 output by the antenna elements of the antenna array. In some examples, the amplifier 210 may be a low noise amplifier. The analog-to-digital converter 213 may be configured to digitize the amplified component signals.

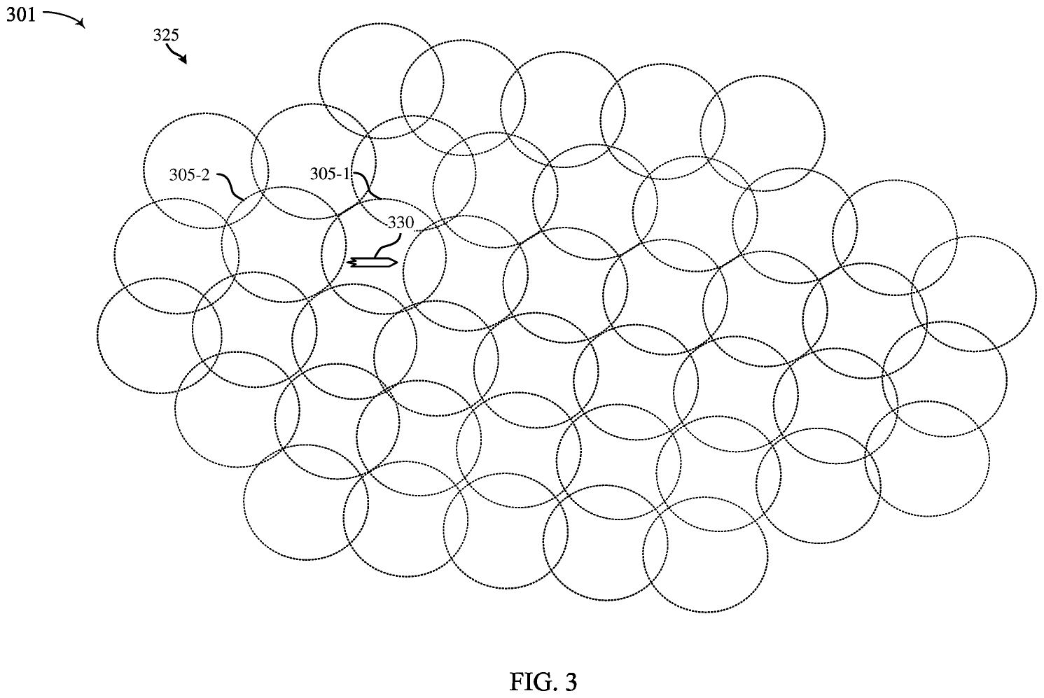

The beamformer 215 may be configured to output multiple beam signals based on the component signals 208, where each beam signal may correspond to a beam and be configured to represent electromagnetic signals originating from a respective beam coverage area. In some examples, the beamformer 215 forms the beams by applying beam coefficients of the beamforming matrix 216 to the signal components output by the antenna elements 207 of the antenna array 205. In such cases, the beamformer 215 may apply the beamforming matrix 216 to the component signals 208 output by the antenna elements 207 (e.g., after amplification and digitization of the component signals 208) of the antenna array 205. The beamforming matrix 216 may be an M×N matrix, where M may correspond to the quantity of the antenna elements 207 and the quantity of component signals 208. N may correspond to the quantity of beams/beam signals output by the beamformer 215. The beamformer 215 may digitally configure the beam coefficients of the beamforming matrix 216 that are applied to the signal components output by the antenna elements 207. In some examples, the beamforming matrix 216 of the beamformer 215 may be used to form an array of beams as described herein, including with reference to FIGS. 3-5.

The signal power detector 220 may be configured to detect a signal power of beam signals received in the beams formed by the beamformer 215. In some examples, information in the beam signals may be representative of thermal noise in respective beam coverage areas. In some examples, the signal power detector 220 is configured to analyze the W-band (from 75 to 110 GHz) because thermal noise may be most pronounced from background noise in the W-band (e.g., for atmospheric reasons). The signal power detector 220 may be further configured to determine a baseline signal power for the area-of-interest (e.g., a baseline thermal noise floor)—based on the signal powers measured from the beam signals. Based on determining the baseline signal power, the signal power detector 220 may monitor respective signal powers of the beams to determine whether a signal power of one or more beams exceeds the baseline signal power by a threshold amount and, in some examples, for a threshold duration. Based on detecting that a signal power of one or more beams satisfies one or more criteria relative to the baseline signal power, the signal power detector 220 may determine that a moving object (e.g., a hypersonic vehicle) is present within the area-of-interest.

The spectral analyzer 225 may be configured to analyze a spectrum of beam signals received in the beams formed by the beamformer 215. In some examples, the beam signals may be representative of radiation emitted by atmospheric molecules, such as molecular oxygen (O₂)—e.g., when disassociation occurs. The spectral analyzer 225 may be further configured to determine a baseline spectral pattern for the area-of-interest—based on the spectral patterns obtained from the beam signals. In some examples, the spectral analyzer 225 may perform long term observation of the earth's atmosphere to determine the baseline spectral pattern of the area-of-interest and may use natural objects (e.g., meteors) and manmade objects (e.g., spacecrafts, rocket bodies, etc.) entering the atmosphere at high velocities for calibration and refinement of the baseline spectral pattern. Based on determining the baseline spectral pattern, the spectral analyzer 225 may monitor respective spectral patterns of the beams to determine whether a spectral pattern of one or more beams satisfies one or more criteria relative to the baseline spectral pattern—e.g., if a width of a spectral line in a spectral pattern of a beam exceeds a width threshold. Based on detecting that a spectral pattern of one or more beams satisfies one or more criteria associated with the baseline spectral pattern, the spectral analyzer 225 may determine that a moving object (e.g., a hypersonic vehicle) is present within the area-of-interest.

In some examples, the spectral analyzer 225 may be configured to analyze a particular portion of the spectrum—e.g., the 60 GHz range of spectrum. In some examples, the spectral analyzer 225 is configured to analyze the 60 GHz range of spectrum based on the 60 GHz range being used for satellite communications (e.g., intersatellite space crosslink communications). Based on configuring the spectral analyzer 225 to analyze the 60 GHz range, a spectral signature of molecular oxygen may be used for vehicle detection based on molecular oxygen having a pronounced spectral line around 60 GHz. The spectral analyzer 225 may include circuitry for downconverting the detected signal component (e.g., the 60 GHz signal component of the spectral signature for molecular oxygen) to a lower band (e.g., the Ka-band) for further processing. The additional circuitry may include a f/4 regenerative frequency divider followed by a heterodyne converter with a local oscillator (e.g., that oscillates at 3.5 GHz). Downconverting the 60 GHz signal to an 18.5 GHz signal may translate the 60 GHz spectral component to the Ka-band for forward link transmission from a satellite to processing on the ground—e.g., if the detection device is located on the satellite and used to relay the signal to the ground.

FIG. 3 shows an example of a beam pattern for an area of-interest that supports detecting hypersonic vehicles in accordance with examples as disclosed herein.

The area-of-interest 301 may include an array of beams 325 forming an array of beam coverage areas (including first beam coverage area 305-1 and second beam coverage area 305-2) that are distributed across an area-of-interest (e.g., an area-of-interest in the lower or upper atmosphere). In some examples, the beam coverage areas may be overlapping with one another. In other examples, the beam coverage areas may be non-overlapping. In some examples, each of the beams of the array of beams 325 is associated with overlapping (e.g., partially or completely) frequency ranges. In some examples, adjacent beams of the array of beams 325 are associated with non-overlapping (e.g., partially or completely) frequency ranges within a frequency range (e.g., the 55 to 75 GHz range, the 75 to 110 GHz range, etc.). That is, adjacent beams of the array of beams 325 may be associated with respective frequency subranges of the frequency range.

A detection device (such as the detection device 200 of FIG. 2) may monitor the beams signals generated for each beam coverage area to determine a signal profile for each beam coverage area—as described herein, including with reference to FIG. 2. A signal profile for a beam coverage area may include a thermal noise profile for a beam signal generated for the beam coverage area, a spectral pattern for a beam signal generated for the beam coverage area, or both. In some examples, the thermal noise profile may be determined based on isolating frequency components of the resulting beam signal that occur over a spectral range (e.g., the 75 to 110 GHz range) and, in some examples, determining an RMS power for the resulting beam signal. In some examples, the spectral pattern may be determined based on applying an FFT to the resulting beam signal over a different spectral range (e.g., the 55 to 75 GHz range)—e.g., based on the spectral range being associated with a signal generated by the dissociation of molecular oxygen.

In some examples, the detection device monitors the noise signals detected in each beam coverage area to identify a thermal noise floor for each beam coverage area. Additionally, or alternatively, the detection device may monitor the frequency components of the spectrum in each beam coverage area to identify a spectral pattern for each beam coverage area. In some examples, the detection device analyzes the noise signals in a first beam coverage area over a first frequency subrange, the noise signals in an adjacent beam coverage area over a second frequency subrange, the noise signals in another adjacent beam coverage area over a third frequency subrange, and so on. In other examples, the detection device may analyze the noise signals in adjacent beam coverage areas over a same frequency range. The detection device may similarly analyze the spectral patterns in the beam coverage areas using frequency subranges or the same frequency range.

For detecting thermal noise floor changes, it is noted that thermally heated objects radiate in all electromagnetic bands including radio frequency bands. Also, a target wall temperature (T_{w}) may be determined based on the equation

$${T}_{w} ( q , {T}_{a} , ε ) := {( \frac{q}{ε * σ} + {T}_{a}^{4} )}^{\text{.25}} ,$$

where q is the heat flux, Tₐ is the ambient temperature, and ε is the emissivity of the target. For surfaces that are not black bodies, the thermal radiation per unit area of radiating surface, solid angle, and bandwidth is approximated by

$$S ( f , {T}_{a} , ε , B W ) : = \frac{2 * h * {f}^{3} * B W * ε}{{c}^{2} * ( {e}^{( \frac{h * f}{k * {T}_{w} ( q , {T}_{a} , ε )} )} - 1 )} ,$$

where f is the center frequency of the receiver, BW is the bandwidth of the receiver, k is Boltzman's constant, h is Planck's constant, and c is the speed of light. Accordingly, the total thermal power that may be captured by the detection device may be based on

$$ThermSNR ( f , {T}_{a} , q , ε , BW , At , Ad , r , {a}_{eff} ) := 10 ⋆ log ( \frac{S ( f , {T}_{a} , ε , B W ) * {A}_{t} * \frac{{A}_{d}}{{A}_{s} ( r )} * {a}_{eff}}{W} ) + 204 ,$$

where α_{eff} is the efficiency of the detector, Aₛ(r) is the surface area of a sphere described by the distance r from the target to the detector, Aₜ is the area of the target, and A_{d} is the area of the detector antenna.

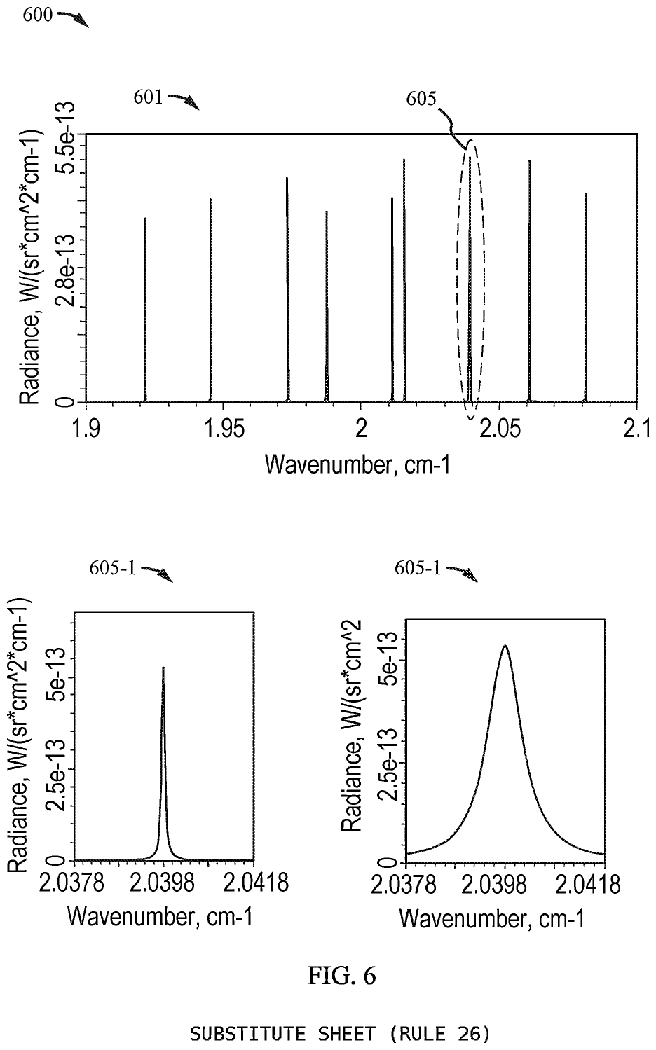

For detecting spectral pattern changes, it is noted that molecules in the atmosphere naturally radiate at certain frequencies—e.g., based on dissociation. For example, dissociation of molecular oxygen causes radiation with spectral lines in the 60 GHz region, where an example spectral lines structure is illustrated with reference to FIG. 6. Pressure increases in the upper atmosphere can cause spectral lines to broaden significantly, as illustrated with reference to the first spectral line 605-1 and the second spectral line 605-2 of FIG. 6. To detect a change in spectral lines, a square law detector may be used that squares and integrates signal samples and compares the result to a threshold value. The threshold value may be selected to maximize the probability of detection subject to a desired false alarm rate.

The detection device may obtain a baseline thermal noise floor for the area-of-interest 301—e.g., by averaging the thermal noise floor measurements obtained from each beam coverage area. Additionally, or alternatively, the detection device may obtain a baseline spectral pattern for the area-of-interest 301—e.g., by combining the spectral patterns for each beam coverage area. Based on establishing baseline parameters, the detection device may monitor each beam coverage area to determine whether any of the beams satisfies a criteria. For example, the detection device may monitor each beam coverage area to determine whether a thermal noise floor of a beam exceeds the baseline thermal noise floor. Additionally, or alternatively, the detection device may monitor each beam coverage area to determine whether a spectral pattern of a beam coverage area differs from the baseline spectral pattern by a threshold amount.

Based on detecting that a thermal noise floor of a beam coverage area (e.g., the first beam coverage area 305-1) satisfies a thermal noise criterion, a spectral pattern of the beam coverage area satisfies a spectral pattern criterion, or both, the detection device may determine that a vehicle (e.g., the vehicle 330) is present in the area-of-interest 301. For example, the detection device may determine that a vehicle 330 is within the area-of-interest 301 if a thermal noise floor of the first beam coverage area 305-1 is greater than a thermal noise threshold (e.g., 0.01 dB). Additionally, or alternatively, the detection device may determine that a vehicle 330 is within the area-of-interest 301 if a spectral line of the first beam coverage area 305-1 (e.g., the spectral line 605 of FIG. 6) is wider than a threshold spectral line.

In some examples, the detection device may only determine that a vehicle is present in the area-of-interest 301 based on detecting multiple beam coverage areas that satisfy the thermal noise criterion, the spectral pattern criterion, or both. For example, the detection device may determine that the vehicle 330 is present in the area of-interest based on detecting that the second beam coverage area 305-2 was previously identified (e.g., within a duration, such as a 0.1 millisecond duration) as satisfying the thermal noise criterion, the spectral pattern criterion, or both. In some examples, the detection device may only determine that the vehicle is present in the area-of-interest 301 if the beam coverage areas that satisfy one or more criteria are adjacent to one another, separated from one another by a threshold quantity of beam coverage areas (e.g., 1 beam), or the like. By limiting vehicle detection to multiple (e.g., adjacent or close) beam coverage areas, false alarms may be avoided.

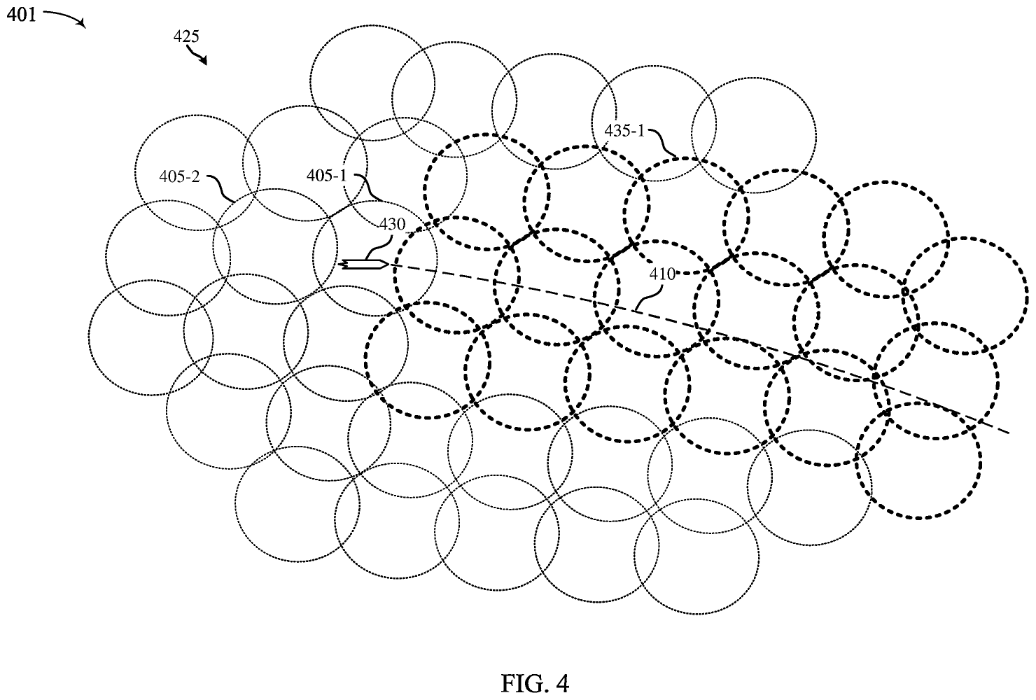

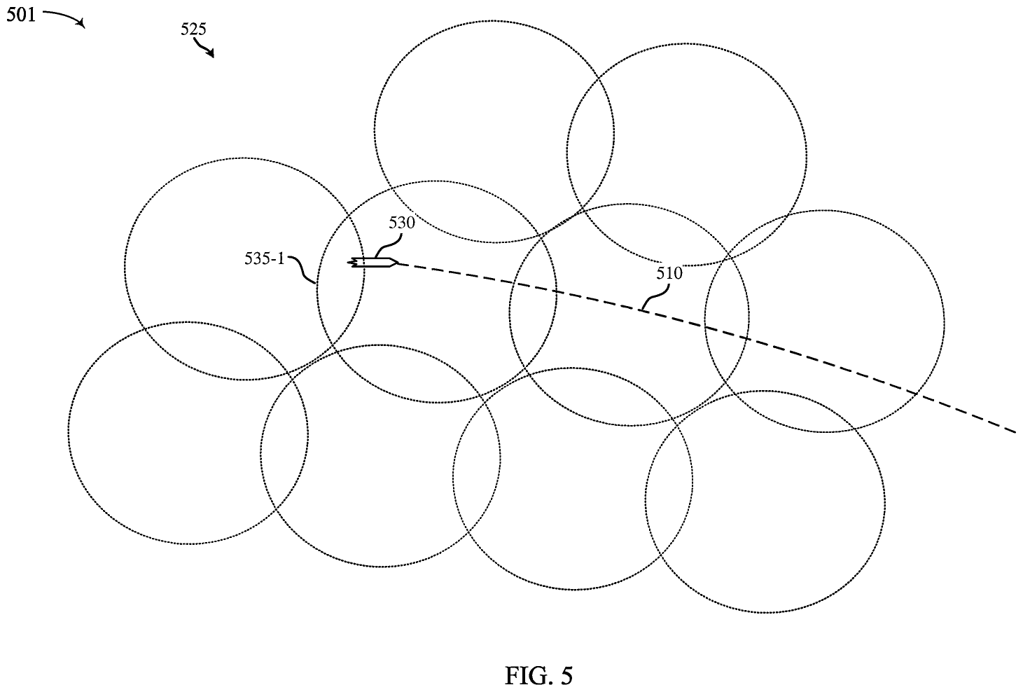

Based on detecting the vehicle 330 in the area-of-interest 301, the detection device may track the movement of the vehicle 330 through the area of-interest. In some examples, the detection device may project one or more trajectories of the vehicle 330 through the area-of-interest 301 based on detection of the vehicle 330 in different beam coverage areas (e.g., based on detecting the vehicle in two or more beam coverage areas). The detection device may use the projected one or more trajectories to focus processing efforts on a subset of the beam coverage areas in the array of beams, as described herein and in more detail with reference to FIGS. 4 and 5.

FIG. 4 shows an example of a beam pattern for an area of-interest that supports detecting hypersonic vehicles in accordance with examples as disclosed herein.

The area-of-interest 401 may be the same as or an example of the area-of-interest 301 of FIG. 3. Similarly, the array of beams 425 and the vehicle 430 may be respective examples of the array of beams 325 and the vehicle 330 of FIG. 3. The vehicle 430 may be projected to travel along the trajectory 410 (although as described herein, the vehicle may deviate from the trajectory 410). Based on determining the trajectory 410, a detection device (such as the detection device 200 of FIG. 2) may focus its processing efforts on the beam coverage areas around the trajectory 410 (the bolded beam coverage areas in FIG. 4, such as the first beam coverage area 435-1). For example, the detection device may focus its processing efforts on the beam coverage areas through which the trajectory 410 passes and the adjacent beam coverage areas. Focusing processing efforts may involve dedicating additional processing resources to processing the signals detected in the selected beam coverage areas, processing the detected signals at a higher frequency rate, and the like. By dedicating processing power to a subset of the beam coverage areas, the detection device may increase a resolution and accuracy with which it may detect vehicles within individual beam coverage areas.

FIG. 5 shows an example of a beam pattern for an area of-interest that supports detecting hypersonic vehicles in accordance with examples as disclosed herein.

The area-of-interest 501 may be the same as or an example of the area-of-interest 301 of FIG. 3 or the area-of-interest 401 of FIG. 4. In some examples, the area-of-interest 501 may at least partially overlap with the area-of-interest 301 of FIG. 3 or the area-of-interest 401 of FIG. 4. Similarly, the vehicle 530 may be an example of the vehicle 530 of FIG. 5. The vehicle 530 may be projected to travel along the trajectory 510 (although as described herein, the vehicle may deviate from the trajectory 510). Based on determining the trajectory 510, a detection device (such as the detection device 200 of FIG. 2) may focus its processing efforts on the beam coverage areas around the trajectory 410. For example, the detection device may direct its antenna elements to form the array of beams 525 having larger beam coverage areas (such as first expanded beam coverage area 535-1) along the trajectory 510. By forming expanded beam coverage areas, the likelihood of detecting a presence of the vehicle 530 may increase—e.g., because the vehicle 530 may spend more time within each beam coverage area, the probability of the vehicle 530 passing through a small portion of the beam coverage area may decrease, and the like. In some examples, a size of the expanded beam coverage areas may be limited to avoid the noise floor of the portions of the expanded beam unaffected by the vehicle 530 from overwhelming the increased noise floor in the portion of the expanded beam affected by the vehicle 530. In some examples, the size of the beam coverage areas may be based on a detected speed of the vehicle 530 e.g., larger beam coverage areas may be selected for faster objects, such as objects that are travelling faster than seven times the speed of sound.

In some examples, rather than forming the array of beams 525 with larger beam coverage areas, an array of beams having smaller beam coverage areas may be formed along the trajectory 510. The smaller beam coverage areas may enable a location and current trajectory of the vehicle 530 to be determined with higher precision than the larger beam coverage areas. In some examples, the detection device may form multiple beam patterns, including a first beam pattern having larger beam coverage areas and a second beam pattern including smaller beam coverage areas e.g., by using multiple beamforming matrices. The multiple beam patterns may be used simultaneously. For example, the larger beam coverage areas may be used for coarser tracking of the vehicle 530 (e.g., to maintain detection of the vehicle 530 in scenarios where the smaller beam coverage areas may lose detection of the vehicle 530) and to identify a set of smaller beam coverage areas for increasing the processing load (e.g., so the location of the vehicle 530 can be determined with more precision). Accordingly, the detection device may avoid the tradeoffs (e.g., in object detection capabilities, positioning capabilities, etc.) associated with selecting one beam coverage area size over another. Also, in some examples, the detection device may analyze the same component signals multiple times by using different beamforming coefficients for a beamforming matrix (that form multiple overlapping beam patterns) to more precisely determine a location of the vehicle 530.

FIG. 6 shows an example of a spectral pattern that supports detecting hypersonic vehicles in accordance with examples as disclosed herein.

The spectral diagram 600 may illustrate the spectral line signature 601 of molecular oxygen in the upper atmosphere. For example, the spectral diagram 600 may illustrate the spectral line signature 601 of molecular oxygen in the 60 GHz region at around a 50 km altitude. The spectral line signature 601 may include the spectral line 605, where the spectral line 605 may have a first shape at a first temperature (e.g., around 271K), as represented by the first spectral line 605-1, and a second shape at a second temperature (e.g., around 3000K), as represented by the second spectral line 605-2.

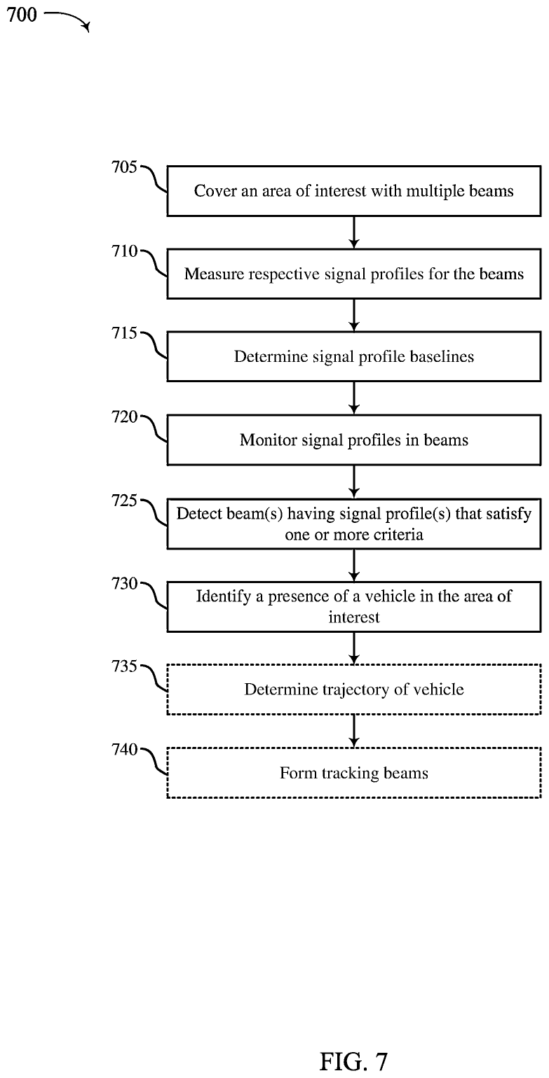

FIG. 7 shows an example of a set of operations for detecting hypersonic vehicles in accordance with examples as disclosed herein.

The flowchart 700 may be performed by a monitoring station described herein. In some examples, the flowchart 700 shows an example set of operations performed to support detecting hypersonic vehicles. For example, the flowchart 700 may include operations for monitoring signal profiles in multiple beams covering an area-of-interest to detect one or more anomalous signal profiles in one or more of the beams that indicates the presence of a fast moving vehicle in the area-of-interest.

Aspects of the flowchart 700 may be implemented by a controller, among other components. Additionally, or alternatively, aspects of the flowchart 700 may be implemented as instructions stored in memory (e.g., firmware stored in a memory coupled with a controller). For example, the instructions, when executed by a controller, may cause the controller to perform the operations of the flowchart 700.

One or more of the operations described in the flowchart 700 may be performed earlier or later, omitted, replaced, supplemented, or combined with another operation. Also, additional operations described herein may replace, supplement or be combined with one or more of the operations described in the flowchart 700.

At 705, an area-of-interest (e.g., an aerial or space-based area-of-interest) may be covered (e.g., by the beamformer 215 of FIG. 2) with multiple beams, as described herein including with reference to FIG. 3. In some examples, the beams may be tessellated across the area-of-interest. In other examples, the beams may be non-uniformly distributed across the area-of-interest.

At 710, signal profiles may be measured (e.g., by the signal power detector 220 and/or the spectral analyzer 225 of FIG. 2) for the beams. In some examples, a signal profile for thermal noise in the beams may be measured (e.g., by the signal power detector 220). The signal profile for signal noise may be measured by detecting and measuring thermal noise in a communication bandwidth (e.g., a 60 GHz bandwidth), a bandwidth that is isolated from other types of noise (e.g., caused by atmospheric activity), or both. Additionally, or alternatively, a signal profile for spectral pattern may be measured (e.g., by the spectral analyzer 225). The signal profile for spectral pattern may be measured by receiving and measuring naturally emitted signals (e.g., by disassociation of molecular oxygen, nitrogen, etc.) in an atmospheric region. In some examples, the signal profile for spectral pattern is obtained by receiving and measuring naturally emitted signals that or near or within a communication bandwidth (e.g., a 60 GHz bandwidth).

At 715, signal profile baselines may be generated (e.g., by the signal power detector 220 and/or the spectral analyzer 225) for the area-of-interest. In some examples, the signal profiles measured across the beams may be combined (e.g., averaged) to obtain a signal profile baseline. For example, the thermal noise floor measured across the beams may be averaged to obtain a thermal noise floor baseline the area-of-interest. Additionally, or alternatively, the spectral pattern measured across the beams may be combined to filter out spectral noise and to obtain a spectral pattern baseline for the area-of-interest.

At 720, respective signal profiles may be monitored (e.g., by the signal power detector 220 and/or the spectral analyzer 225) in the respective beams. In some examples, the respective thermal noise floors may be measured (e.g., by the signal power detector 220) in each beam. Additionally, or alternatively, the respective spectral patterns may be measured (e.g., by the spectral analyzer 225) in each beam.

At 725, it may be detected (e.g., by the signal power detector 220 and/or the spectral analyzer 225) that one or more signal profiles measured for one or more of the beams satisfies one or more criteria. For example, it may be detected (e.g., by the signal power detector 220) that the thermal noise floor in a beam exceeds the baseline thermal noise floor determined for the area-of-interest. In some examples, it may be detected that the thermal noise floor exceeds the baseline thermal noise floor for a predetermined duration (e.g., to filter out false alarms). In some cases, it may be detected that the thermal noise floor in another beam exceeds the baseline thermal noise floor threshold. The beams may be adjacent or within a threshold quantity of beams from one another.

Additionally, or alternatively, it may be detected (e.g., by the spectral analyzer 225) that the spectral signature in a beam differs from a baseline spectral signature determined for the area-of-interest by a threshold amount e.g., as described herein including with reference to FIG. 6. In some examples, it may be detected that the spectral signature differs from the baseline spectral signature for a predetermined duration (e.g., to filter out false alarms). In some cases, it may be detected that the spectral signature in another beam differs from the baseline spectral signature by a threshold amount. The beams may be adjacent or within a threshold quantity of beams from one another. In some examples, the spectral signature may be associated with a spectral signature of molecular oxygen. In some examples, the difference between a measured spectral signature and the baseline spectral signature may be determined based on a shape (e.g., a width) of one or more spectral lines in the measured spectral signature relative to the baseline spectral signature.

In some examples, the thermal noise floor in one beam may be detected as exceeding the baseline thermal noise floor threshold, and the spectral signature in another beam may be detected as differing from a baseline spectral signature. The beams may be adjacent or within a threshold quantity of beams from one another.

At 730, a presence of a vehicle in the area-of-interest may be detected (e.g., by the processor 217 of FIG. 2) based on one or more signal profiles in one or more of the beams begin detected as satisfying at least one criteria. In some examples, the presence of the vehicle is detected based on the thermal noise floor in a beam exceeding a baseline thermal noise floor threshold. Additionally, or alternatively, the presence of the vehicle is detected based on the spectral signature in a beam differing from a baseline spectral signature. In some cases, the vehicle is detected based on either the thermal noise floor or the spectral signature satisfying a respective criteria in one beam and the thermal noise floor or the spectral signature satisfying a respective criteria in another beam. In some examples, the beams may be adjacent to one another or within a threshold quantity of beams from one another. Additionally, or alternatively, the criteria in the beams may be satisfied within a threshold duration of one another.

By waiting to detect the satisfying of the criteria in in multiple beams (e.g., within a threshold duration of one another), the false alarms associated with anomalies in single beams may be reduced.

At 735, a trajectory of a detected vehicle may be projected (e.g., by the processor 217). In some examples, the trajectory may be detected based on detecting the vehicle in multiple beams. For example, a trajectory of the vehicle may be determined based on a relative position of two or more beams in which the vehicle is detected, a determined speed of the vehicle, and the like. In some examples, the projected trajectory includes multiple possible trajectories, and the trajectory is continually updated as the vehicle travels through the area-of-interest.

At 740, tracking beams may be formed (e.g., by the beamformer 215). In some examples, the tracking beams may be formed based on the projected trajectory for a detected vehicle—e.g., as described herein including with reference to FIGS. 4 and 5. Additionally, or alternatively, based on detecting the vehicle, tracking beams with larger coverage areas may be formed—e.g., as described herein including with reference to FIG. 5. In some examples, an increased level of processing power may be allocated to the tracking beams (e.g., more cores may be dedicated to the tracking beams, a higher frequency may be used, the processor may operate in a higher power mode, or the like) relative to the prior detection beams.

In some examples, an apparatus as described herein may perform a method or methods, such as the method described with reference to flowchart 700. The apparatus may include features, circuitry, logic, means, or instructions (e.g., a non-transitory computer-readable medium storing instructions executable by a processor), or any combination thereof for performing the following aspects of the present disclosure:

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein.

A method is described. The method may include forming a plurality of beams (125) comprising a plurality of coverage areas (305) that cover an area-of-interest (301), measuring, for the plurality of beams (125), respective signal profiles associated with respective coverage areas of the plurality of coverage areas (305), detecting, for a beam of the plurality of beams (125), a signal profile that satisfies a criterion relative to the respective signal profiles in one or more other beams of the plurality of beams (125), and identifying a presence of a vehicle (130) in the area-of-interest (301) based at least in part on detecting that the signal profile satisfies the criterion.

An apparatus is described. The apparatus may include a processor, memory coupled with the processor, and instructions stored in the memory. The instructions may be executable by the processor to cause the apparatus to form a plurality of beams (125) comprising a plurality of coverage areas (305) that cover an area-of-interest (301), measure, for the plurality of beams (125), respective signal profiles associated with respective coverage areas of the plurality of coverage areas (305), detect, for a beam of the plurality of beams (125), a signal profile that satisfies a criterion relative to the respective signal profiles in one or more other beams of the plurality of beams (125), and identify a presence of a vehicle (130) in the area-of-interest (301) based at least in part on detecting that the signal profile satisfies the criterion.

Another apparatus is described. The apparatus may include means for forming a plurality of beams (125) comprising a plurality of coverage areas (305) that cover an area-of-interest (301), means for measuring, for the plurality of beams (125), respective signal profiles associated with respective coverage areas of the plurality of coverage areas (305), means for detecting, for a beam of the plurality of beams (125), a signal profile that satisfies a criterion relative to the respective signal profiles in one or more other beams of the plurality of beams (125), and means for identifying a presence of a vehicle (130) in the area-of-interest (301) based at least in part on detecting that the signal profile satisfies the criterion.

A non-transitory computer-readable medium storing code is described. The code may include instructions executable by a processor to form a plurality of beams (125) comprising a plurality of coverage areas (305) that cover an area-of-interest (301), measure, for the plurality of beams (125), respective signal profiles associated with respective coverage areas of the plurality of coverage areas (305), detect, for a beam of the plurality of beams (125), a signal profile that satisfies a criterion relative to the respective signal profiles in one or more other beams of the plurality of beams (125), and identify a presence of a vehicle (130) in the area-of-interest (301) based at least in part on detecting that the signal profile satisfies the criterion.

In some examples of the method, apparatuses, and non-transitory computer-readable medium described herein, the plurality of beams (125) may be a first plurality of beams (325) and the method, apparatuses, and non-transitory computer-readable medium may include further operations, features, means, or instructions for forming, based at least in part on identifying the vehicle (330), in the area-of-interest (301), a second plurality of beams (525) comprising a second plurality of coverage areas (535) that cover a second area-of-interest (501).

Some examples of the method, apparatuses, and non-transitory computer-readable medium described herein may further include operations, features, means, or instructions for projecting, based at least in part on identifying the presence of the vehicle (330) in the area-of-interest (301), a trajectory (510) of the vehicle (330), wherein the second area-of-interest (501) covered by the second plurality of beams (525) may be based at least in part on the trajectory (510) projected for the vehicle (330).

In some examples of the method, apparatuses, and non-transitory computer-readable medium described herein, a quantity of the second plurality of beams (525) may be less than a quantity of the first plurality of beams (325), a size of coverage areas of the second plurality of coverage areas (535) may be greater than a size of coverage areas of the first plurality of coverage areas (305), and the second area-of-interest (501) at least partially overlaps with the first area-of-interest (301), or any combination thereof.

In some examples of the method, apparatuses, and non-transitory computer-readable medium described herein, the beam may be a first beam and the signal profile may be a first signal profile and the method, apparatuses, and non-transitory computer-readable medium may include further operations, features, means, or instructions for detecting, in a second beam of the plurality of beams (125) and after detecting the first signal profile in the beam, a second signal profile that satisfies the criterion and projecting a trajectory (410) of the vehicle (330) based at least in part on a location of the first beam relative to a location of the second beam.

In some examples of the method, apparatuses, and non-transitory computer-readable medium described herein, the beam may be a first beam and the signal profile may be a first signal profile and the method, apparatuses, and non-transitory computer-readable medium may include further operations, features, means, or instructions for detecting, in a second beam of the plurality of beams (125) that may be adjacent to the first beam and within a threshold duration of detecting the first signal profile in the first beam, a second signal profile that satisfies the criterion and wherein the presence of the vehicle (330) may be identified based at least in part on detecting that signal profiles in adjacent beams of the plurality of beams (125) satisfy the criterion.

Some examples of the method, apparatuses, and non-transitory computer-readable medium described herein may further include operations, features, means, or instructions for measuring the respective signal profiles comprises measuring respective thermal noise floors in the respective coverage areas of the plurality of coverage areas (305) and detecting the signal profile satisfies the criterion comprises detecting that a thermal noise floor in the beam may be higher than an average thermal noise floor for the plurality of beams (125) by a threshold amount.

In some examples of the method, apparatuses, and non-transitory computer-readable medium described herein, detecting that the thermal noise floor in the beam may be higher than the average thermal noise floor may include operations, features, means, or instructions for calculating an average signal power for the respective thermal noise floors detected in the plurality of beams (125) and determining that a signal power of the thermal noise floor in the beam exceeds the average signal power by the threshold amount.

Some examples of the method, apparatuses, and non-transitory computer-readable medium described herein may further include operations, features, means, or instructions for measuring the respective signal profiles comprises analyzing respective spectrum of the respective coverage areas of the plurality of coverage areas (305) and detecting the signal profile satisfies the criterion comprises detecting a change in a spectral line signature (601) for a spectrum of a coverage area of the beam.

In some examples of the method, apparatuses, and non-transitory computer-readable medium described herein, the spectral line signature (601) may be based at least in part on a disassociation of oxygen and the change in the spectral line signature (601) may be caused by a change in atmospheric temperature or a change in atmospheric pressure caused by the vehicle (330) travelling through the coverage area.

In some examples of the method, apparatuses, and non-transitory computer-readable medium described herein, the vehicle (330) may be travelling through the area-of-interest (301) at a hypersonic speed.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer readable media may include RAM, ROM, electrically erasable programmable read-only memory (EEPROM), flash memory, compact disk read-only memory (CDROM) or other optical disk storage, magnetic disk storage or other magnetic storage devices, or any other non-transitory medium that can be used to carry or store desired program code means in the form of instructions or data structures and that can be accessed by a general purpose or special purpose computer, or a general purpose or special purpose processor. Also, any connection is properly termed a computer readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu ray disc where disks usually reproduce data magnetically, while discs reproduce data optically with lasers. Combinations of the above are also included within the scope of computer readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A system, comprising:
an antenna array comprising a plurality of antenna elements configured to output component signals;
a beamformer coupled with the plurality of antenna elements and configured to apply a beamforming matrix to the component signals received at the plurality of antenna elements to form a plurality of beams comprising a plurality of coverage areas that cover an area-of-interest; and
a processor configured to:
measure, for the plurality of beams, respective signal profiles associated with respective coverage areas of the plurality of coverage areas;
detect, for a beam of the plurality of beams, a signal profile that satisfies a criterion relative to the respective signal profiles in one or more other beams of the plurality of beams; and
identify a presence of a vehicle in the area-of-interest based at least in part on detecting that the signal profile satisfies the criterion.

2. The system of claim 1, wherein the plurality of beams is a first plurality of beams, the plurality of coverage areas is a first plurality of coverage areas, and the area-of-interest is a first area-of-interest, and wherein the processor is further configured to:
form, based at least in part on identifying the vehicle, in the first area-of-interest, a second plurality of beams comprising a second plurality of coverage areas that cover a second area-of-interest.

3. The system of claim 2, wherein the processor is further configured to:
project, based at least in part on identifying the presence of the vehicle in the area-of-interest, a trajectory of the vehicle, wherein the second area-of-interest covered by the second plurality of beams is based at least in part on the trajectory projected for the vehicle.

4. The system of claim 2, wherein:
a quantity of the second plurality of beams is less than a quantity of the first plurality of beams;
a size of coverage areas of the second plurality of coverage areas are greater than a size of coverage areas of the first plurality of coverage areas; or
the second area-of-interest at least partially overlaps with the first area-of-interest.

5. The system of claim 1, wherein the beam is a first beam and the signal profile is a first signal profile, and wherein the processor is further configured to:
detect, in a second beam of the plurality of beams and after detecting the first signal profile in the beam, a second signal profile that satisfies the criterion; and
project a trajectory of the vehicle based at least in part on a location of the first beam relative to a location of the second beam.

6. The system of claim 1, wherein the beam is a first beam and the signal profile is a first signal profile, and wherein the processor is further configured to:
detect, in a second beam of the plurality of beams that is adjacent to the first beam and within a threshold duration of detecting the first signal profile in the first beam, a second signal profile that satisfies the criterion,
wherein the presence of the vehicle is identified based at least in part on detecting that signal profiles in adjacent beams of the plurality of beams satisfy the criterion.

7. The system of claim 1, wherein:
to measure the respective signal profiles, the processor is further configured to measure respective thermal noise floors in the respective coverage areas of the plurality of coverage areas, and
to detect the signal profile satisfies the criterion, the processor is further configured to detect that a thermal noise floor in the beam is higher than an average thermal noise floor for the plurality of beams by a threshold amount.

8. The system of claim 7, wherein, to detect that the thermal noise floor in the beam is higher than the average thermal noise floor, the processor is further configured to:
calculate an average signal power for the respective thermal noise floors detected in the plurality of beams, and
determine that a signal power of the thermal noise floor in the beam exceeds the average signal power by the threshold amount.

9. The system of claim 1, wherein:
to measure the respective signal profiles, the processor is further configured to analyze respective spectral patterns associated with signals originating from the respective coverage areas of the plurality of coverage areas, and
to detect the signal profile satisfies the criterion, the processor is further configured to detect a change in a spectral line signature for a spectral pattern associated with a coverage area of the beam.

10. The system of claim 9, wherein:
the spectral line signature is based at least in part on a disassociation of oxygen, and
the change in the spectral line signature is caused by a change in atmospheric temperature or a change in atmospheric pressure caused by the vehicle travelling through the coverage area at a hypersonic speed.

11. The system of claim 1, further comprising:
a ground-based node that comprises the plurality of antenna elements;
an aerial-based node that comprises the plurality of antenna elements; or
a space-based node that comprises the plurality of antenna elements.

12. The system of claim 1, wherein the plurality of antenna elements are positioned below the area-of-interest.

13. A method, comprising:
forming a plurality of beams comprising a plurality of coverage areas that cover an area-of-interest;
measuring, for the plurality of beams, respective signal profiles associated with respective coverage areas of the plurality of coverage areas;
detecting, for a beam of the plurality of beams, a signal profile that satisfies a criterion relative to the respective signal profiles in one or more other beams of the plurality of beams; and
identifying a presence of a vehicle in the area-of-interest based at least in part on detecting that the signal profile satisfies the criterion.

14. The method of claim 13, wherein the plurality of beams is a first plurality of beams, the plurality of coverage areas is a first plurality of coverage areas, and the area-of-interest is a first area-of-interest, and wherein the method further comprises:
forming, based at least in part on identifying the vehicle, in the area-of-interest, a second plurality of beams comprising a second plurality of coverage areas that cover a second area-of-interest.

15. The method of claim 14, further comprising:
projecting, based at least in part on identifying the presence of the vehicle in the area-of-interest, a trajectory of the vehicle, wherein the second area-of-interest covered by the second plurality of beams is based at least in part on the trajectory projected for the vehicle.

16. The method of claim 14, wherein:
a quantity of the second plurality of beams is less than a quantity of the first plurality of beams,
a size of coverage areas of the second plurality of coverage areas are greater than a size of coverage areas of the first plurality of coverage areas, and
the second area-of-interest at least partially overlaps with the first area-of-interest, or any combination thereof.

17. The method of claim 13, wherein the beam is a first beam and the signal profile is a first signal profile, and wherein the method further comprising:
detecting, in a second beam of the plurality of beams and after detecting the first signal profile in the beam, a second signal profile that satisfies the criterion; and
projecting a trajectory of the vehicle based at least in part on a location of the first beam relative to a location of the second beam.

18. The method of claim 13, wherein the beam is a first beam and the signal profile is a first signal profile, the method further comprising:
detecting, in a second beam of the plurality of beams that is adjacent to the first beam and within a threshold duration of detecting the first signal profile in the first beam, a second signal profile that satisfies the criterion,
wherein the presence of the vehicle is identified based at least in part on detecting that signal profiles in adjacent beams of the plurality of beams satisfy the criterion.

19. The method of claim 13, wherein:
measuring the respective signal profiles comprises measuring respective thermal noise floors in the respective coverage areas of the plurality of coverage areas, and
detecting the signal profile satisfies the criterion comprises detecting that a thermal noise floor in the beam is higher than an average thermal noise floor for the plurality of beams by a threshold amount.

20. The method of claim 19, wherein detecting that the thermal noise floor in the beam is higher than the average thermal noise floor comprises:
calculating an average signal power for the respective thermal noise floors detected in the plurality of beams, and
determining that a signal power of the thermal noise floor in the beam exceeds the average signal power by the threshold amount.

21. The method of claim 13, wherein:
measuring the respective signal profiles comprises analyzing respective spectrum of the respective coverage areas of the plurality of coverage areas, and
detecting the signal profile satisfies the criterion comprises detecting a change in a spectral line signature for a spectrum of a coverage area of the beam.

22. The method of claim 21, wherein:
the spectral line signature is based at least in part on a disassociation of oxygen, and
the change in the spectral line signature is caused by a change in atmospheric temperature or a change in atmospheric pressure caused by the vehicle travelling through the coverage area.

23. The method of claim 13, wherein the vehicle is travelling through the area-of-interest at a hypersonic speed.
